(19) United States
(12) Patent Application Publication
(10) Pub. No.: US 2014/0082014 A1
(43) Pub. Date: Mar. 20, 2014

(54) ABSTRACT, STRUCTURED DATA STORE QUERYING TECHNOLOGY

(71) Applicant: Logics Research Centre SIA, Riga (LV)

(72) Inventors: Mikus Vanags, Riga (LV); Arturs Licis, Riga (LV); Janis Justs, Riga (LV)

(73) Assignee: LOGICS RESEARCH CENTRE SIA, Riga (LV)

(21) Appl. No.: 13/781,804

(22) Filed: Mar. 1, 2013

Related U.S. Application Data
(60) Provisional application No. 61/606,042, filed on Mar. 2, 2012.

(51) Int. Cl. G06F 17/30

(52) U.S. Cl. CPC G06F 17/30424
USPC 707/769

(57) ABSTRACT

The present invention is abstract, structured data store querying technology (system) which is capable of running deduction process in environment disconnected from data store. Logic programming engines does not know which facts it will need to correctly process questions (queries) and they require loading in memory and processing all data store content. Problem is solved introducing an abstraction: meta-set, which is able to describe one or more facts (becoming meta-facts). This way it is possible to separate data store from logic programming engine turning it into meta-set calculus engine which combines meta-facts and rules to build resulting list of meta-sets which will be used to auto-generate queries to data store. Proposed solution allows running deduction process in distributed environments where deduction can be performed on the client tier, and queries for real objects will be sent to centralized data store servers.

### CROSS-REFERENCE TO RELATED APPLICATIONS

This application claims the benefit of U.S. Provisional Application No. 61/606,042, filed 2 Mar. 2012.

### REFERENCES CITED

### U.S. Patent Documents

| | | | |
|---|---|---|---|
| 1. | 2007/0027849 | A1 February 2007 | Meijer et al. |
| 2. | 7,860,823 | B2 December 2010 | Hejlsberg et al. |
| 3. | 8,255,883 | B2 August 2012 | Sceppa et al. |

### Other Sources

4. LINQ-.NET Language Integrated Query [retrieved on 26-02-2013]. Retrieved from the Internet: http://msdn.microsoft.com/en-us/netframework/aa904594.
5. Bratko I. 2000. Prolog Programming for Artificial Intelligence. Pearson, UK.
6. Stansifer R. 1994. The Study of Programming Languages. Prentice Hall, New Jersey, USA.
7. Pierce B. C. 2002. Types and programming languages. MIT Press, London, England.
8. Raul Rojas. A Tutorial Introduction to the Lambda Calculus [retrieved on 26-02-2013]. Retrieved from the Internet: http://www.utdallas.edu/˜gupta/courses/apl/lambda.pdf.
9. MDA—Model Driven Architecture [retrieved on 26-02-2013]. Retrieved from the Internet: http://www.omg.org/mda/.
10. Second-order logic [retrieved on 26-02-2013]. Retrieved from the Internet: http://en.wikipedia.org/wiki/Second-order_logic.
11. S. Marc Cohen. 2004. Second Order Logic [retrieved on 26-02-2013]. Retrieved from the Internet: http://faculty.washington.edu/smcohen/120/SecondOrder.pdf.
12. Db4o—Database For Objects [retrieved on 26-02-2013]. Retrieved from the Internet: http://www.db4o.com/.
13. SODA—Simple Object Database Access [retrieved on 26-02-2013]. Retrieved from the Internet: http://sourceforge.net/projects/sodaquery/.
14. DLR Expression Tree Specification [retrieved on 26-02-2013]. Retrieved from the Internet: http://dlr.codeplex.com/wikipage?title=Docs %20and%20specs&referringTitle=Documentation.
15. LINO TO SQL [retrieved on 26-02-2013]. Retrieved from the Internet: http://msdn.microsoft.com/en-us/library/bb386976.aspx.
16. Microsoft Visual Studio Code Name “Orcas” Language-Integrated Query, May 2006 Community Technology Preview [retrieved on 26-02-2013]. Retrieved from the Internet: http://www.microsoft.com/download/en/details.aspx?displaylang=en&id=11289.

### BRIEF DESCRIPTION OF DRAWINGS

The system and methods for abstract, structured data store querying technology are further described with reference to the accompanying drawings in which:

FIG. 1. show physical class structure used in many code examples.

FIG. 2. show generalized meta-set physical structure.

FIG. 3. show layered structure of DDE (Decentralized Deduction Engine).

FIG. 4. show conceptual schema of deduction process in DDE.

FIG. 5. show question processing workflow in DDE.

FIG. 6. show SODA query generated from meta-set:
<Person>[Pets contains <Dog>[Trained=True]]|n.

FIG. 7. show SODA query generated from meta-set:
<Dog>[Age=3]{different(<Dog>[Trained=True])}.

FIG. 8. demonstrates Prolog like rule declaration syntax that is possible to be achieved in C# programming language.

FIG. 9. demonstrates two variable usages in rule definition.

FIG. 10. show declaration of rule expression (expression tree instance)—person who owns at least one pet.

### BACKGROUND

Expert systems are one of the best artificial intelligence solutions, and deductive database is a technical tool for creating them. Many different expert systems and deductive databases exist, but most of them use their own syntax which is not comfortable to use together with modern object oriented languages. Not only expert system shells uses different syntax but each data store uses more or less different querying syntax. In different database querying can help abstractions like LINQ—Language Integrated Query (1) (4). But LINQ can't help in cases when deduction is needed, because such system would request to load in memory all database content to work correctly. Described problem can be solved with another abstraction: meta-set (object set abstraction). Classic predicate logic as it is implemented in logic programming language Prolog (5) does not work with meta-sets.

Logic programming engine is a system which allows specifying the desired solution using predicate logic, and logic programming engine will find the solution automatically. Logic programming involves objects, variables and predicates—relationships between objects (6). For example:

father (John, Ann).
father is predicate and it defines relationship between objects John and Ann, meaning that John (first term) is father of Ann (second term). John and Ann are called terms of predicate father. Terms can be objects, variables or even predicates.
In logic programming it is possible to:

Declare facts about objects and relationships:
dog(Duksis). dog(Reksis). trained(Duksis).

Define rules about objects and relationships:
trainedDog(x):—dog(x), trained(x).
Operator:—represents logical operation “is implied by”, x represents variable and comma represents logical AND operator.

Ask questions about objects and relationships:
trainedDog(n)?
The systems returned answer in this case will be:
n=Duksis.

Logical OR operator in logic programming is implemented as two different rules defining one predicate, for example:

trainedAnimal(x):—trainedDog(x).
trainedAnimal(x):—cat(x), trained(x).

Logic programming supports functors—uninterpreted functional symbols. When any term in some predicate1 is not object and not variable, but some predicate2, then predicate1 is called functor. Using functors one can build data structures where the only use of objects is to stand in relations. For example:

book(TheMatingMind, author(Geoffrey, Miller)).
Predicate book is functor, because its second term is also predicate.

Most logic programming systems provide meta-logical (meta-logical predicates are those that take relations as arguments) relation NOT that succeeds only when its argument fails. In such cases knowledge base does not contain facts, which proves argument of NOT operator—it means only absence of proof of argument and not presence of proof that argument fails. In case when argument of NOT operator succeeds result of NOT operator fails immediately and does continue searching for more proofs that argument of NOT operator succeeds.

Logic programming systems also can provide CUT operator which allows cutting search space.

More abstract thinking leads to a better design (7). There're many existing abstractions (interfaces, inheritance, type systems, etc.), logics (combinatory logic, propositional logic, predicate logic, etc.), formal calculus (for example lambda calculus which extends combinatory logic with mathematical function abstraction (8)), approaches, e.g., MDA (9) (MDA defines only axiomatic rules and gives model and meta-model description syntax; however, development of transformation logic is left up to developers so such approaches can't be used unambiguously). Examples of abstractions with its meta, meta-meta, and so on . . . , models lead to a question how to classify a system which will work with meta-sets. As proposed, system is based on modified predicate logic, it is not only approach based on axiomatic rules; it is logic or at least mathematical formalism. Expressions written in formal calculus can be transformed into underlying logic; example of such case is lambda calculus transformations to combinatory logic and vice versa. Proposed system is based on predicate logic, but meta-set processing operations can't be described by simple predicate logic expressions, so the meta-set system proposed is not a traditional predicate logic system and can't be transformed into it. First order predicate logic uses variables that range over individual objects, but second order logic involves variables which range over sets of individual objects (10) (11). Meta-set is object set abstraction and meta-set calculus is based on second order predicate logic, but meta-sets are used instead of object sets. Meta-sets contain neither real objects, nor references to real objects; meta-sets can contain only constraints which can be used to generate database query and retrieve set of objects.

The difference between predicate logic and meta-set calculus which works with meta-sets is in the way of how facts (business objects) are processed. When working with facts directly, logic programming engine needs to load all database content into memory for deduction process to work. This problem is solved in decentralized deduction engine (meta-set engine) by introducing meta-set (abstraction of business objects). One meta-fact can describe many facts, so the number of meta-facts will be significantly less than a number of total facts in business object database. This way meta-set calculus engine would perform much faster and more importantly—it will be independent of business object database content allowing deduction process decentralization.

NOTE: In this invention is compared first order predicate logic with variant of second order predicate logic: meta-set calculus. This is main reason why this paper does not cover detailed meta-set calculus comparison to Prolog, DataLog and other first order predicate logic systems. First order predicate logic systems can use different approaches to simulate sets, for example, using lists, but lists are not mathematical abstractions, and lists are data structures which are restricted to contain finite number of objects while sets as mathematical abstractions can describe infinite number of objects.

### SUMMARY

The present invention is abstract, structured data store querying technology (system). The core components that together make up the architecture of the system are: module for transforming input to form needed for decentralized deduction engine; input normalization module; decentralized deduction engine which consists of meta-set calculus engine (can work with set abstractions) and data store query generation module.

Proposed solution is based on meta-set calculus which is kind of second order predicate logic. Meta-set calculus differs from pure second order predicate logic with abstraction: meta-set. Meta-set consists of type constraints, property-value constraints and set constraints. Deduction in meta-set calculus engine is performed using abstractions, not business objects loaded from database. This idea provides possibility to separate logic programming layer from database layer, and to separate process of logic reasoning from business objects. This increases performance of the system, and reduces coupling between system components. As meta-set calculus engine does not depend on business object database, it can be used as basis to create querying language for databases. Proposed prolog like querying language concept could replace standard querying languages in specific database implementations raising level of type safety, query parts reuse and adding deduction feature to database querying.

### DETAILED DESCRIPTION

Each meta-set can contain 3 different constraint lists: type constraints, property-value constraints and object set constraints. Here is proposed syntax for meta-set declaration:

<type constraints> [property-value constraints] {object set constraints} |
bound_Variable

Mandatory part consists of type constraints which always come before other constraints. Property-value constraints and object set constraints are optional and can be omitted. Each constraint can be declared together with NOT operator, but that does not change type of the constraint. If meta-set contains more than one same type constraints, they are separated by commas. Bound variable is optional and is used only to represent meta-set processing operations during logical deduction process; bound variable is not used in any other way—it should not be stored in database or used to generate database query.

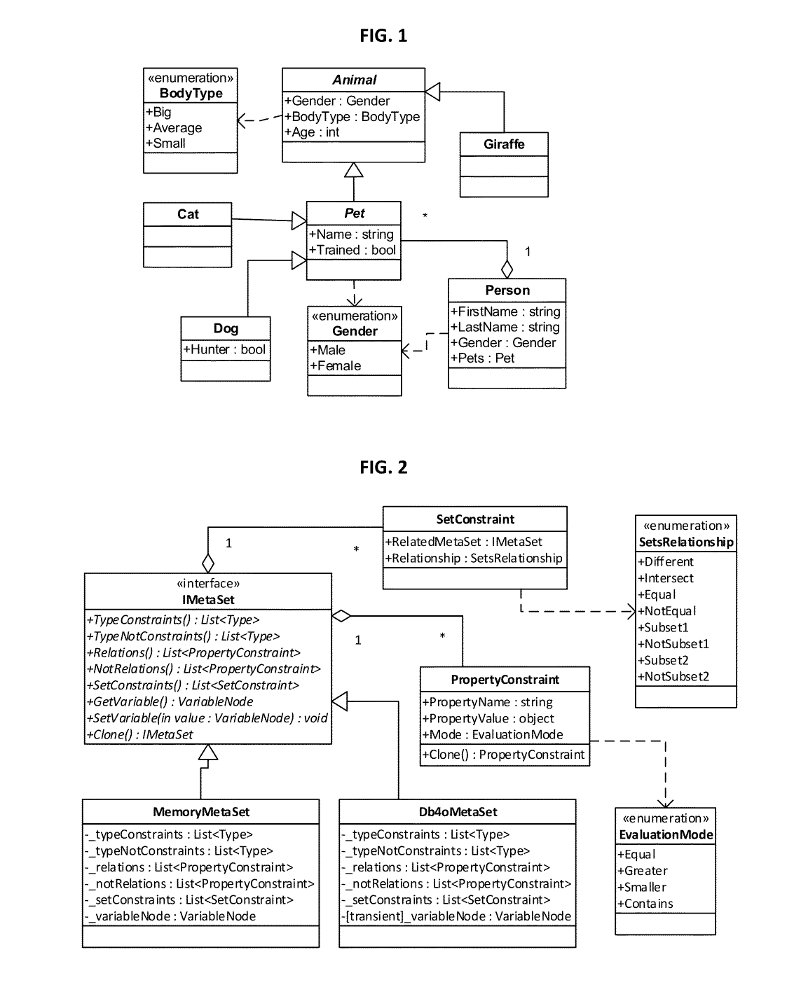

Type constraints constrain types of objects that meta-set represented set of objects should contain. When type constraints are used together with NOT operator, resulting constraints represent types of objects that meta-set represented set of objects should not contain. Meta-set calculus is designed for use in object oriented environments and meta-set type constraints support such abstractions as type inheritance and interface implementation. For better illustration of type constraint processing in meta-set calculus, including meta-set matching and unification (6), most of meta-set examples provided in this article uses class diagram shown in FIG. 1.

Example of meta-set which restricts object types to be subclass of Animal, and at the same time not subclass of Dog:
<Animal, not(Dog)>
According to class diagram shown in FIG. 1, query generated from previously declared meta-set would return all instances of class Cat and class Giraffe objects, because these classes inherits from class Animal and does not inherit class Dog.
When using NOT operator for type constraint declaration, it is advised to provide at least one type constraint which isn't used together with NOT operator, because query building system in each database is implemented in different way and such unambiguous queries can lead to unexpected results (for example when provided type constraint in NOT context without usual type constraint, database db4o 8.1 (12). interprets it as type constraint ignoring NOT context). In object oriented environment it is useful to use interfaces in constraining types of object set individual objects.
Property-value constraints provide desired value range limitation for specified property. Following is proposed syntax for property-value constraint description:

### [PropertyName EvaluationMode ConstrainedValue]

In pure meta-set calculus 4 different property-value constraint EvaluationMode forms are supported: Equal, Greater, Smaller, and Contains. Following example demonstrates meta-set which represents dogs which are younger than 3 years and are not trained:
<Dog>[Age<3,not(Trained=True)]
Property-value constraints can be not only simple value constraints, but also complex constraints constraining type of property returning object and values of its properties. Such complex constraint can be set as another meta-set containing desired type constraints, property-value constraints and even object set constraints. Next example shows how to declare complex meta-set which represents set of persons which has (meaning: property Pets contains) at least one trained dog.
<Person>[Pets contains <Dog>[_trained=True]]
Object set constraints are special for second order predicate calculus, and by using object set constraints it is possible to define relationships between two different meta-sets. Meta-set can be interpreted as query to database which returns set of objects. Sometimes it's necessary to define relationships between different sets of objects. Object set constraint can be represented by the following syntax:

### {SetsRelationship(meta-set)}

Relationships of object sets are always defined between two sets represented by meta-sets: first is meta-set which contains object set constraints list (context meta-set) and second is meta-set used as object set constraint. In case when it is needed to define relationships between more than two meta-sets it is possible to add more object set constraints.
SetsRelationship can be one of 8 supported meta-set relationship forms:
Different—two sets of objects does not contain common objects.
Intersect—two sets of objects have at least one common object.
Equal—two sets of objects are equal—contain equal objects.
NotEqual—two sets are not equal. It does not definitely mean that they are different, it means that two object sets are either different or intersect (including cases when one set is subset of another set).
Subset1—the first set (represented by context meta-set) is subset of the second set (declared as object set constraint).
NotSubset1—the first set (represented by context meta-set) is not subset of the second set (declared as object set constraint). It means that two object sets are either different, intersect or the second set is subset of the first set.
Subset2—the second set (declared as object set constraint) is subset of the first set (represented by context meta-set).
NotSubset2—the second set (declared as object set constraint) is not subset of the first set (represented by context meta-set). It means that two object sets are either different, intersect or the first set is subset of the second set.

Next example shows how to declare meta-set which represents all dogs that are not trained dogs:

<Dog>{different(<Dog>[Trained=True])}
Equivalent SQL query would be as follows:

SELECT * FROM Dogs
EXCEPT
SELECT * FROM Dogs WHERE Trained=‘True’;

Logic programming engine works with objects, but logic programming engine can be modified to work also with meta-sets. In such case predicate terms could be meta-sets. For example:

dog(<Dog>).
trained(<Pet>[Trained=True]).

Meta-sets do not change behaviour of variables, so meta-set usage does not change rule declaration syntax. Here is example of rule which uses fact declared using meta-sets:
trainedDog(x):—dog(x), trained(x).
In logic programming syntactically identical objects match, but unlike objects do not match. As far as matching is concerned there is no difference in the treatment of atoms and terms. The difference that is crucial is between variables and non-variables. For example:
female(Ineta) matches with female(Ineta)
female(Ineta) matches with female(x) binding variable x to object Ineta
female(Ineta) does not match with female(Alice).
Meta-set matching differs from object matching, because meta-sets are like small parts of larger query that is being built and not all differences in meta-sets are considered as failures in matching. For example:

something(<Dog>) matches with something(<Dog>)
something(<Dog>) matches with something(<Pet>)
something(<Dog>) matches with something(<Animal>)
something(<Dog>) does not match with something(<Cat>)
something(<Dog>) does not match with something(<Person>)
something(<Dog>) matches with something(x). Matching does not
reference variables with meta-set instances, but unification does.

In unification, when meta-set type constraints matches and if in matching was used variable, then meta-set to which the variable references, will contain updated list with most specific type constraints from both meta-sets, merged lists of both meta-set property-value constraints and set-constraints and also variable name which references to meta-set. For example, if knowledge base contains following facts:

dog(<Dog>).
trained(<Pet>[Trained=True]).

and following rule:
trainedDog(x):—dog(x), trained(x).
Then, asking question trainedDog(n)? to meta-set calculus engine will lead to unifying trainedDog(n) with trainedDog(x) and in result variable x will be bound to variable n and new list of goals would be dog(n) and trained(n). Dog(n) will match with dog(<Dog>) from knowledge base leading to reference variable n with copy of meta-set <Dog>|n and remaining goal will be updated to: trained(<Dog>|n). Trained(<Dog>|n) would match with trained(<Pet>[Trained=True]) leading to updating variable n referenced meta-set <Dog>|n to <Dog>[Trained=True]|n. Now goals list would be empty and variable n points to meta-set <Dog>[Trained=True]|n what is the answer to question and reference to variable n is no more needed.
NOTE: meta-set <Dog>|n contains reference back to variable n. Such reference is needed only for meta-set calculus engine to work correctly and it is not necessary to be stored to database to save meta-sets correctly.

Unification using NOT operator works similarly, with the difference that constraints under NOT operator context are marked with NOT marks and constraints which already were marked with NOT marks are released from NOT marks. For example, if rule base would contain rule notTrainedDog:

notTrainedDog(x):—dog(x), not(trained(x)).
Then meta-set calculus engine to question notTrainedDog(n)? would give answer: <Dog>[not(Trained=True)]|n.

All necessary meta-sets can be created before using them in deduction process, that is more type-safe and saves calculations needed to dynamically form meta-set, but meta-sets also can be created dynamically during deduction process. Dynamic meta-set creation is possible using special operators.

Type constraint operator: IsOfType adds type constraint to meta-set. IsOfType can be used together with NOT operator. For example:

animal(<Animal>).
neededAnimal(x) :- animal(x),not(isOfType<Dog>(x)).

Processing rule neededAnimal during deduction process will lead to creation of the following meta-set:

### <Animal,not(Dog)>|x.

Pure meta-set calculus supports 4 different property-value comparison operators: equalTo, greater, smaller, contains. All property-value comparison operators can be used together with NOT operator. Property-value comparison operator usage syntax:
operator(meta-set, “propertyName”, propertyValue).
As result of using property-value comparison operator, in meta-set property-value constraint list will be added new constraint. For example:

person(<Person>).
adultPerson(x):-person(x),greater(x, “Age”, 18).

Processing rule adultPerson during deduction process will lead to creation of the following meta-set:

### <Person>[Age>18]|x.

Pure meta-set calculus supports 5 different object set operators: different, intersect, equal, subset1, subset2 which together with Not operator forms 3 additional set relationships: NotEqual, NotSubset1, NotSubset2. Set operator usage syntax:
setOperator(metaset1, metaset2).
For example, operator different can be used to declare predicate dogDifferentThanTrainedDog:

dog(<Dog>).
trained(<Pet>[Trained=True]).
dogDifferentThanTrainedDog(x) :- dog(x), dog(y), trained(y),
different(x,y).

Processing rule dogDifferentThanTrainedDog during deduction process will lead to creation of the following meta-set:
<Dog>{different(<Dog>[Trained=True])}|x.

In logic programming expression not(P) detects presence or absence of theorem P proof in rule base. In such case operator NOT stops search when is found the first proof supporting P, but such behavior is not correct for meta-set calculus, because meta-sets are not real objects and fact not(P) in meta-set case should be persisted in meta-set P as constraint. Meta-set calculus also requires searching knowledge base for all operator NOT argument proofs, only this way it is possible to get correct NOT constraints for all involved meta-sets in the deduction process.

NOT operator can be used together with all previously mentioned operators except operator “is implied by”. When NOT used together with AND or OR operators, De Morgan's laws are applied to simplify expressions.

In all previously reviewed example questions were asked using only one variable, but logic programming allows asking questions with more than one variable, for example:

father(x, y)?
In such case logic programming engine will return all father-son pairs, in form:

x=Father1, y=Son1;
x=Father2, y=Son2.
...

Meta-set calculus also supports such feature. But as meta-sets are set of abstractions and represent queries to database, in cases when asking questions with many variables to meta-set calculus engine as result will be executed as many queries as variables present in question. Theoretically each query generated from resulting meta-sets could return resulting objects ordered in different ways causing inconsistence according to asked question. Such behaviour is natural because meta-sets by definition represent object sets and in sets objects are not ordered, but object order is important in answering the question. To solve this problem meta-set calculus engine should perform some query results synchronization, for example, in case of predicate father, father objects probably will contain list of sons, so in such case the son object querying should be performed not over the database, but over the sons list of appropriate father objects. Sometimes required meta-sets will not be so close related as an example of father and son, in such cases expected result would be Cartesian product of objects gathered from queries generated from involved meta-sets.

Sometimes rule declaration could contain more parts separated with logical OR operator. In cases when these parts have similar structure (predicates) but the difference is only in terms, like in this example:

predicate1(X) :- predicate2(X).
predicate1(X) :- predicate2(7).

Such rule also can be rewritten in one row by using OR operator:
predicate1(X):—predicate2(X) OR predicate2(7).
But it is also possible to improve rule declaration syntax as follows:
predicate1(X):—predicate2(X OR 7).
In such case rule normalization will be performed before deduction process and rule will be separated back in two parts. Similarly it is possible to use AND operator, for example this rule:
predicate1(X):—predicate2(X AND 7).
during normalization process will be rewritten to:
predicate1(X):—predicate2(X), predicate2(7).
This syntax improvement feature is more important in concrete meta-set calculus engine implementation than in Prolog like syntax used in meta-set calculus description, because Prolog like syntax uses comma as AND operator and comma also is used in term separation inside of predicates. This leads to two different syntactical forms of AND operators in Prolog like syntax which is at least odd. Also, meta-set calculus engine architectural design proposed in this article allows syntactical AND and OR operator use as terms in another predicates and such use of AND and OR operators should be interpreted somehow.

FIG. 2 shows generalized meta-set physical structure, where property TypeConstraints is intended to contain type constraints for business objects located in database and TypeNotConstraints should contain type constraints with applied logical operation NOT. Relations contain property-value constraints and are the basic aspect of meta-set abstraction. E.g., if business object database contain 1000 people and 200 of them are younger than 20 years, then all these 200 people (facts) can be described with one meta-set which contains the following single relation in its Relations collection: Age <20. Similarly is processed NotRelation collection which describes property-value constraints what desired object set should not contain.

Methods GetVariable and SetVariable are used by meta-set calculus engine to hold temporarily bound variable. Such information is needed only in deduction process and does not require to be stored into database, that's why in meta-set realization for database db4o (Database For Objects) field “variable” is marked with attribute [Transient].
Class Type is used to generalize approach of defining type constraints. In most cases it would be enough to define string representations of types so that they could be persisted (in case of db4o, for type constraint storing and retrieving are used object translators which translates Type objects to String instances and vice versa. Type, CultureInfo and some other system type instances depend on .NET internal behavior and are difficult to store in database).

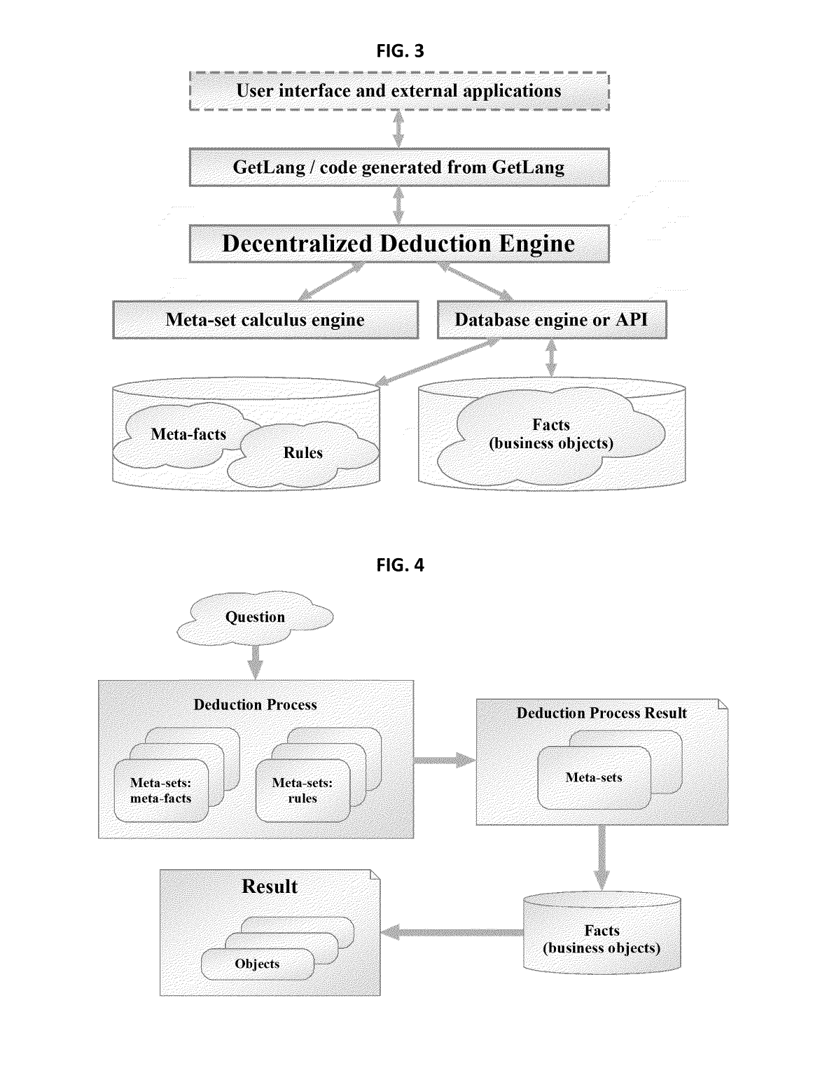

FIG. 3 depicts the architecture of DDE where it interacts with meta-set calculus engine and data store querying API to provide interface for managing structured data deductive database. The benefit of such architecture is business object database separation from meta-sets (meta-facts) and rules database where rules are similar to meta-facts with the only difference that meta-facts describe facts, but rules combine meta-facts. Such separation improves meta-fact reusability and allows keeping centralized only business objects, while deduction specific information can be located on client computers and each client can have different meta-facts and rules based on their specific needs.

DDE connects user interface or external code calls through DDE API calls with meta-set calculus engine and data store. FIG. 4 depicts generalized schema of operations what DDE does. The result of deduction process is a collection of meta-sets and if database contains more than one instance of each type (for relation databases it means more than one row in each table), the number of resulting meta-sets would be significantly smaller than number or querying objects in database. The structure of meta-set is similar to simple object data access (SODA) (13) query structure used in object data bases, thus collection of meta-sets is used to automatically generated object database SODA query to retrieve business objects from business object database. This is why DDE does not need to load all database content into memory to work correctly.

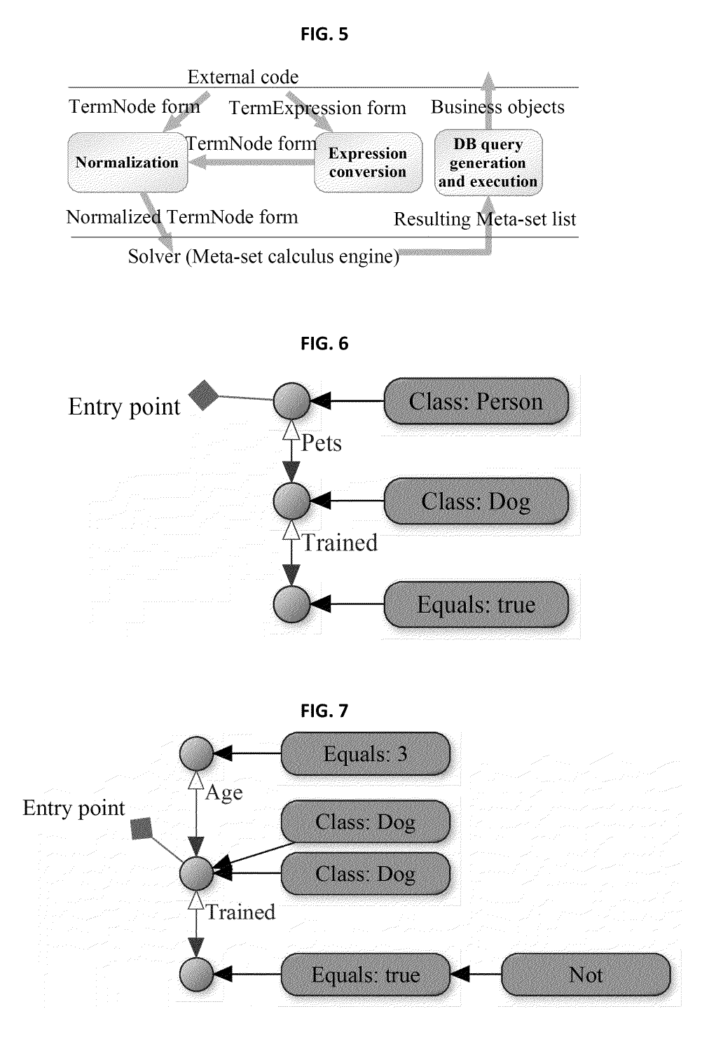

FIG. 5 depicts question processing workflow in DDE showing two different forms of questions DDE accepts and how these question forms are processed.

Solver (meta-set calculus engine) works with TermNode instances transformed in conjunctive normal form. DDE handles all necessary normalizations, but still main data structure for DDE is TermNode instances, because TermNode instances can be stored in data stores and TermNode instances are platform independent. Here is example of defining TermNode instance in C# code:

var ageConstraint = new PropertyConstraint(“Age”, 30,
EvaluationMode.Smaller);
var metaYoungPerson = new MetaSet(typeof(Person), new[ ]
{ ageConstraint });
var youngPerson = new TermNode(“youngPerson”, new object[ ]
{ metaYoungPerson });

Expressions in TermNode form are not short, not type safe and not user-friendly. To solve these problems in DDE are employed function types (delegates) which creates TermNode instances. Here is example of defining fact that person is young using DDE built-in delegates:

var youngPerson = Func.Arity1(“youngPerson”);
TermNode fact = youngPerson(metaYoungPerson);

Delegates can help in fact declaration, but using delegate provided syntax is not enough to declare rules and questions with variables in nice looking way. That is why in DDE introduced TermExpression form. TermExpression form is based on expression tree (2, 3, 14) use similarly as does LINQ to SQL (15) and other data store LINQ providers. Variables in TermExpression form are declared as lambda expression parameters and as result is prolog like syntax in native C# code:

var youngPerson = Func.Arity1(“youngPerson”);
var male = Func.Arity1(“male”);
var youngMalePerson = Func.Arity1(“youngMalePerson”);
Expression<Func<object, TermNode>> rule = a =>
youngMalePerson(a) == youngPerson(a) & male(a));

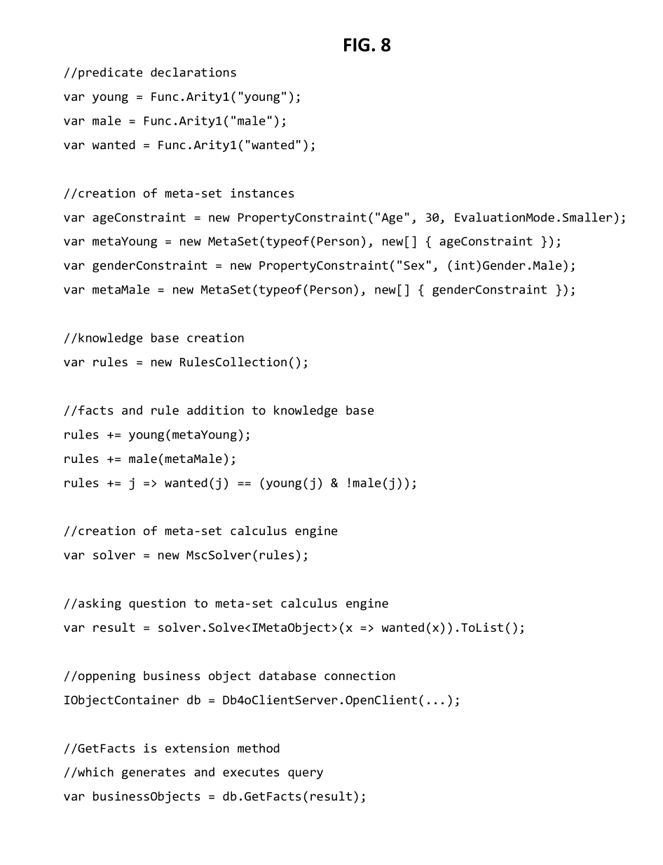

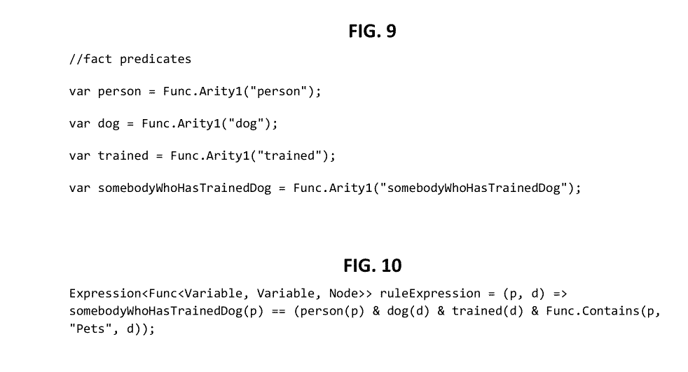

Here C#'s overloaded operator “==” represents operator “is implied by” in meta-set calculus.
Idea about prolog like syntax in native C# code was firstly introduced by Microsoft in LINQ CTP May 2006 as LogicProgramming sample project (16)16. LINQ project became part of .NET 3.5, but LogicProgramming sample project quietly disappeared. In authors opinion that happened not because Microsoft was trying to hide some potentially valuable ideas, but because project was difficult to understand for usual programmers and prolog like syntax without meta-set calculus is useless. To work properly, logic programming engine requires access to all database content, in worst case leading to loading in memory all database content that is not the case with meta-set calculus engine.
FIG. 8 demonstrates Prolog like rule declaration syntax that is possible to be achieved in C# programming language using expression trees.
More complex example shown in FIG. 9 demonstrates two variable usages in rule definition.
Rule expression declaration example is shown in FIG. 10 demonstrating definition of abstraction—person who owns at least one pet. Note: when adding rule expression:
rules+=ruleExpression
to knowledge base, transformation from term expression form to TermNode form is performed automatically.

TermExpression form is based on expression trees, which are not trivial to persist in data stores. TermExpressions can contain references to function pointers and user created objects located on heap. Such things are specific for physical computer on which application is running. Expression tree instances can be serialized, but when deserialized on different computer than the one used for serialization, function pointers and pointers to user object instances would point to memory locations where objects are on initial computer and that would lead to exception. TermExpression form uses .NET standard delegate Func overloaded versions and that means arity restriction not more than 17 terms in each predicate. So, rules and questions declared using TermExpression syntax are nice-looking, type safe, but far away not platform independent and anyway needs to be converted to TermNode form for Solver to work.

TermExpressions are converted by recursively inspecting expression tree instances and creating resulting TermNode objects. To avoid code duplications in standard operators like AND, OR, NOT, Equal and standard operator expressions in expression trees, from expression trees are taken only parameters and supplied in appropriate standard operator calls this way building resulting TermNode instance.
Results returned from execution of all standard operators (predicates), user defined predicates and built-in predicates are represented as TermNode instances. This means that, AND, OR, NOT, Contains, Different, Equals, other built-in predicates and even operator “is implied by” are represented as TermNode instances. This feature will be useful in communication between different computers, because every expression can be converted in single TermNode instance.

Meta-set calculus engine works only with normalized TermNode instances in conjunctive normal form. But before conjunctive normalization execution are performed following actions: reduction of nested NOT operators using De Morgan's laws and other normalizations.

Meta-set calculus engine is based on modified unification which combines constraints of meta-sets as described earlier. Modified unification supports both: meta-sets and business objects, but such hybrid deduction engine is complex and depending on future research about meta-set calculus technology use cases, unification improvements could evolve mainly in two different scenarios: unification which supports only meta-sets and hybrid unification supporting both: meta-sets and business objects. Meta-set-only unification is suitable for database querying and deduction support, which is more attractive to business world, while hybrid unification could be useful in expert system shells.

NOT operator implementation in meta-set calculus engine is simpler than described in pure meta-set calculus description. Physical meta-set model contains two lists for type constraints shown in FIG. 2: one list for constraints without applied NOT operator and one list for type constraints with applied NOT operator. When meta-set calculus engine detects meta-set in unifying predicate from knowledge base, type constraints from unifying predicate are added to according type constraint lists of resulting meta-set. But when meta-set calculus engine detects NOT predicate, content of list TypeNotConstraints of unifying meta-set located in knowledge base is copied to list TypeConstraints of resulting meta-set and content of list TypeConstraints from unifying meta-set are copied to list TypeNotConstraints of resulting meta-set. Similarly are processed property-value constraints in NOT operator context. Such constraint lists for constraints without applied NOT operator and with applied NOT operator is useful when considering future changes. For example, invention of new constraints would not require changes in whole constraint handling system and the same constraints will continue to work correctly also in combination with NOT operator. Only object set constraints are stored in one constraint list, because object set constraints are more complex and can't be classified only in two different groups. Object set constraints change SetsRelationship enumeration value to represent if object set constraint is or is not used together with NOT operator.

Built-in predicate processing is performed by meta-set calculus engine during deduction process. That is why NOT operator and previously described predicates such as IsTypeOf, Greater, Smaller, EqualTo, Contains, Different, Equal, Subset1, Subset2 and Intersect builds resulting meta-sets dynamically. If possible it is better to declare facts providing full desired meta-set specification than using dynamic meta-set building. Dynamic meta-set building performs slower and is less type safe.

Database query generation is most important part in DDE after meta-set calculus engine. In current DDE prototype is supported only SODA query generation to database db4o. Next example demonstrates how query is generated from deduced meta-set. Assume that knowledge base contains following facts:

dog(<Dog>).
trained(<Pet>[Trained=True]).
person(<Person>).

Also assume that knowledge base contains rule:
personWhoOwnsDog(x):—person(x), dog(y), trained(y), contains(x, “Pets”, y).
Under such assumptions question personWhoOwnsDog(n)? would lead to following answer:
<Person>[Pets contains <Dog>[Trained=True]]|n.
And from that meta-set DDE auto generates SODA query shown in FIG. 6 (idea of SODA query representation is taken from db4o supporting documentation (12)). After successful query generation, query is executed and gathered objects are returned to user who asked question to DDE system.

Query generation from meta-sets containing only type constraints and property-value constraints are simple. Problematic is query generation from meta-sets containing set constraints, because not all databases support set operators. In cases when required database system does not support set operators, for example, set operator subset1(metaset1, metaset2), then DDE generates separate queries for metaset1 and metaset2, executes them and processes returned objects from queries the way they comply with used set operator, for example—subset1.

While not all set operations are supported in db4o, it is possible to generate SODA queries from meta-sets containing set constraint: different. For example, for following meta-set:
<Dog>[Age=3]{different(<Dog>[Trained=True])}|x
will be generated SODA query shown in FIG. 7, where all meta-sets which set relationship: different are processed as questions to deduction system with applied NOT operator. Generated SODA query contains two equal type constraints (type of Dog) and query generation can be improved to contain only one instance of most specific type constraints from all involved meta-sets.

Current implementation of DDE supports database query generation from meta-sets for database db4o, but in similar way it is possible to add query generation support from meta-sets for other key-value stores which stores key-value pairs in structured way, for example XML files. It is also possible to add support for relational database query generation from meta-sets, but in this field is needed more research, because SQL queries can contain join operations which is problematic to interpret in object oriented world. Join operator allows selecting parts from different tables, but object-oriented world requests all objects and not only parts of many objects. Problem could be solved interpreting queries with join operations as requests for some dynamically generated objects (LINQ to SQL works in similar way), but better approach could be support of multiple class inheritance in programming frameworks.

What is claimed is:

1. Abstract, structured data store querying system comprising: input normalization module (input is accepted as TermNode (data structure suitable for logic programming solver to work) instance or many instances defining facts, meta-facts, rules or questions); decentralized deduction engine which consists of meta-set calculus engine (based on second order predicate calculus and can work with set abstractions) and data store query generation module.

2. The system of claim 1 wherein the system contains additional module for transforming TermExpression (expression tree) instance to appropriate list of TermNode instances. In result the system can accept input in form of TermExpression instance or many instances.

3. The system of claim 1 wherein the input normalization module can detect facts, meta-facts, rules or questions containing operators (predicates): AND, OR, IsImpliedBy, and any other operator supported by the system which should be interpreted.

4. The system of claim 3 where input normalization module can interpret system operators contained in input supplied to system.

5. Method of logic programming engine (solver) which can work with set abstractions (meta-sets).

6. The method of claim 5 wherein the meta-sets can contain one or more Type Constraints. When solver detects that meta-set type constraints matches and if in matching was used variable, then meta-set to which the variable references, will contain updated list with most specific type constraints (taking into consideration type inheritance) from both meta-sets.

7. The method of claim 6 wherein the meta-sets can contain one or more Property-Value Constraints and the meta-set to which the variable references, will contain merged list Property-Value Constraints from both matching meta-sets.

8. The method of claim 7 wherein the meta-sets can contain one or more Set-Constraints and the meta-set to which the variable references, will contain merged list of Set-Constraints from both matching meta-sets.

9. The method of claim 5 wherein Type Constraints are passed to solver dynamically—using system supported operators (predicates).

10. The method of claim 5 wherein Property-Value Constraints are passed to solver dynamically—using system supported operators (predicates).

11. The method of claim 5 wherein Set Constraints are passed to solver dynamically—using system supported operators (predicates).

12. The method of claim 5 wherein Property-Value Constraints in value part can contain abstractions (meta-sets) instead of concrete values.

13. The method of claim 5 wherein the solver supports NOT operator in such way solver searches knowledge base for all operator NOT argument proofs.

14. The method of claim 13 wherein if meta-set under operator NOT context does not contain Property-Value constraints then Type Constraints of that meta-sets are marked with NOT marks and Type Constraints which already were marked with NOT marks are released from NOT marks.

15. The method of claim 13 wherein Property-Value Constraints in operator NOT context are marked with NOT marks and constraints which already were marked with NOT marks are released from NOT marks.

16. The method of claim 13 wherein Set Constraints in operator NOT context are changed to opposite Set Constraints according to rules of set algebra.
